(19) United States
(12) Patent Application Publication
(10) Pub. No.: US 2026/0357932 A1
(43) Pub. Date: Nov. 12, 2026

(54) AUXILIARY SEALING SYSTEM FOR FLANGED CONNECTIONS

(71) Applicant: ERAM TECHNOLOGIES S.R.L., Gragano Trebbiense (IT)

(72) Inventor: Mauro FRANCIOSI, Gragnano Trebbiense (PC) (IT)

(21) Appl. No.: 19/515,669

(22) PCT Filed: Sep. 12, 2024
(86) PCT No.: PCT/IB2024/058861

§ 371 Date: Mar. 2, 2026

(30) Foreign Application Priority Data
Sep. 12, 2023 (IT) 102023000018735

(51) Int. Cl. F16L 23/18; F16L 23/036

(52) U.S. Cl. CPC F16L 23/18; F16L 23/036

(57) ABSTRACT

An auxiliary sealing system (10) for flanged connections which comprises an annular element (20) to be applied to the flanges (4, 5) of the connection, the annular element (20) is circumferentially closed on itself and has opposing seats (21, 22) for at least partially receiving the flanges (4, 5) so as to circumferentially circumscribe the corresponding flange (4,5) when it is received in the corresponding seat (21, 22), each seat (21, 22) is provided with sealing connection means (26) with the corresponding flange (4, 5).

### TECHNICAL FIELD

The invention relates to an auxiliary or safety sealing system for flanged connections suitable for improving the safety characteristics of such connections in installations in which pipelines can circulate fluids which are hazardous both as a result of the temperature characteristics and/or pressure characteristics and as a result of chemical/physical characteristics of the fluids themselves.

### TECHNOLOGICAL BACKGROUND

Flanged connections are one of the most widespread means for connecting together, generally head to head, two or more pipelines and the relevant components also having the ends flanged (valves, instruments, filters, pumps and other devices forming part of the pipelines). They comprise a pair of flanges which are fixed to the corresponding facing ends of the tubes to be joined (the flanges are normally joined to the tubes by means of welding) and which are fixed to each other generally by screw and bolt type connections. The fluid-tightness of the connection is ensured by one or more gaskets which are interposed between the flanges and clamped therebetween. It is evident that, in the event of failure or loss of the gasket system, there is generated a localized uncontrolled loss of the fluid which circulates in the installation. It is known in particular in installations for circulating vapour at high temperatures to use, at the flanged connections, sheet metal deflectors which serve to direct and screen the flow of a potential loss as a result of failure of the gasket away from persons and objects so as to limit the danger to which the operators can be exposed in the vicinity. However, such deflectors do not allow any recovery of the loss which is therefore dispersed in the surrounding area.

Logically, this solution is unacceptable when particularly hazardous fluids circulate in the installations, for example, hydrogen, flammable, poisonous or particularly aggressive liquids and gases.

There is known from U.S. Pat. No. 5,564,715 a gasket structure for flanged connections which is particularly robust in order to overcome these types of disadvantages. However, it is clear that even the most robust gasket is also potentially subjected to failures or losses and, in this case, the solution proposed by this document is generally ineffective.

US20140077492 and U.S. Pat. No. 8,191,993 describe connections which are provided with gaskets which are surrounded by a containment ring. This ring serves mainly to correctly position the gasket between the flanges and to provide improved resistance in the event that pressurized fluids or fluids at high temperatures circulate in the installation. However, the problem of a possible failure of the gasket is neither confronted nor solved by this solution.

US20170130881 describes a flanged connection in which an elastomer gasket is protected by two metal shells. The system is proposed to safeguard the gasket but does not provide any protection in the event of damage thereto.

EP132997 describes a protector for gaskets of flanged connections including an annular element which is formed by a resilient gasket which is made from a band of plastics material which has a normally linear development and which can be applied around a flanged joint in order to be retained there via the closure of a metal clamp. The resilient structure is described by indicating that only when it is applied to surround the flanged connection does it take up a closed-ring-like configuration. The clamp and relevant rod are other components which make the protector non-unitary, and therefore unsuitable for providing auxiliary protection for flanged connections in installations in which fluids which are hazardous and/or at high pressures and/or high temperatures can circulate.

DE3509775 describes an auxiliary protection which is similarly surrounded by a metal clamp which is closed by a fastening of the type conventionally used for closing ski boots. This document does not set out an annular element which is suitable for severe applications with high loads.

The problem addressed by the present invention is to provide an auxiliary or safety sealing system for flanged connections which is structurally and functionally configured to overcome at least some of the disadvantages set out with reference to the cited prior art.

In this context, a main object of the invention is to provide an auxiliary sealing system which allows any losses from the flanged connection to be safely recovered.

Another important object is to obtain the results set out above with a simple structure which is not subjected to occurrences of jamming or malfunctions.

Another object is to provide a sealing system which is suitable for operating with hazardous fluids in substantial safety.

This problem is solved and at least some of these objects are achieved by means of an auxiliary or safety sealing system for flanged connections which is constructed according to one or more of the features of the appended claims.

In one aspect of the invention, the auxiliary sealing system comprises an annular element to be applied to the flanges. Preferably, the annular element is circumferentially closed and, still in a preferable manner, has opposing seats for at least partially receiving the respective flanges so as to circumferentially circumscribe the corresponding flange when it is received in the corresponding seat. In an important aspect of the invention, each seat is provided with sealing connection means with the corresponding flange so as to define between said flanges and said annular element a circumscribed sealing environment. In this manner, any losses of the flanged connection are completely contained by the auxiliary sealing system.

According to another aspect of the invention, there are provided clamping screws and nuts of the flanges provided with sealing connection means between the screws and the nuts and/or between the nuts and the flanges. In this manner, the losses of the flanged connection through the clamping screws passage holes are contained inside the auxiliary sealing system.

Preferably, the above-mentioned seats are coaxial and extend axially in the annular element. This allows the application of the auxiliary sealing system to coaxial flanged connections which are the most widespread ones.

According to another important aspect of the invention, the sealing between each seat and the corresponding flange is circumferential and is applied between the mutually overlapping portions between seats and flanges. By using a circumferential sealing between the seats and the corresponding flanges, any losses of the flanged connection are completely contained by the auxiliary sealing system.

Preferably, the annular element has, in a position between the seats of the flanges, an annular projection which projects radially towards the interior of the annular element.

In an exemplary embodiment of the invention, this annular projection has such an axial thickness substantially as to compensate for any gaskets interposed between the flanges and preferably has such a radial thickness as to be interposed between the flanges when the joint is assembled and clamped.

In the annular element there may be formed at least one intercommunication passage between said sealed circumscribed environment and the external environment. This passage may have multiple purposes, for example, the controlled discharge of any leaks through the gasket and/or the arrangement of sensors and/or transducers or simple caps.

In one exemplary embodiment, said passage can be intercepted.

There is advantageously provision for the sealing means between the screws and the nuts to be formed by blind nuts and/or for the sealing means between the nuts and the flanges to comprise gaskets interposed between a base of each nut and the respective flange.

### BRIEF DESCRIPTION OF THE DRAWINGS

The features and advantages of the invention will be better appreciated from the following detailed description of a preferred embodiment thereof which is illustrated, by way of non-limiting example, with reference to the appended drawings, in which:

FIG. 1 is a perspective view of a flanged connection provided with an auxiliary sealing system according to the invention;

FIG. 2 is a partially sectioned view of the sealing system of FIG. 1;

FIG. 3 is a sectioned detail of the sealing system of the preceding Figures;

FIGS. 4 and 5 are a perspective view and a partially-sectioned front view, respectively, of another detail of the sealing system of the invention;

FIG. 6 is a front view of another detail of the invention.

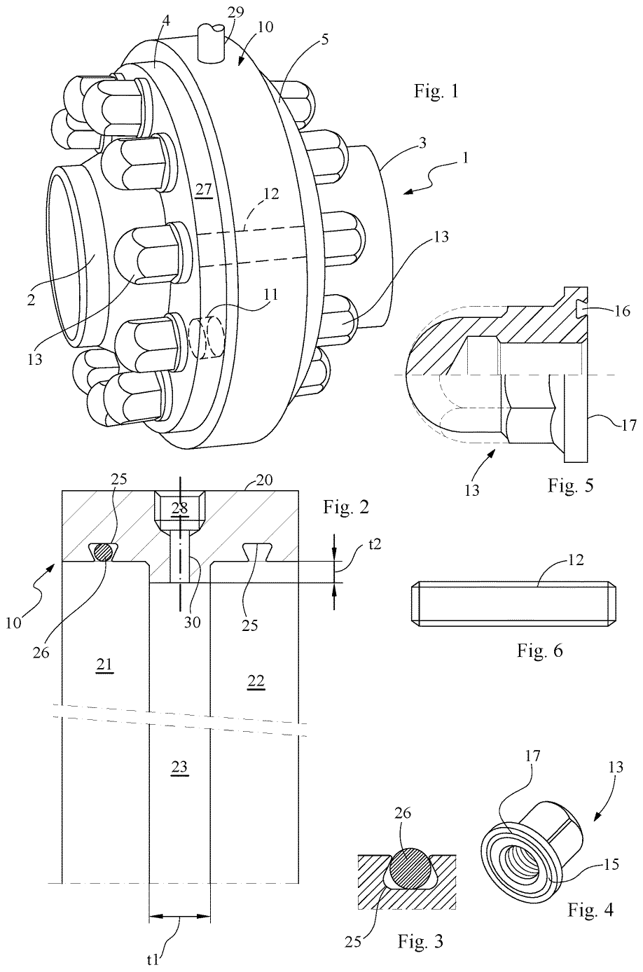

### PREFERRED EMBODIMENT OF THE INVENTION

In the Figures, by the reference number 1 there is generally designated a flanged connection between two pipeline portions 2, 3, each having a respective flange 4, 5 and being fitted with an auxiliary or safety sealing system 10 according to the invention. The presence of pipeline portions 2, 3 is generally incidental and represents one of the possible applications of the invention. Other types of application which are evident to a person skilled in the art are, for example, direct flanged connections between machine parts and/or installation parts.

Each flange 4, 5 has at least one (or more) ring of through-holes 11 which are arranged in a corresponding manner on the two flanges so that these holes are aligned when the flanges are beside each other in order to receive connection means, for example and preferably, of the screw 12 and bolt 13 type. The screws 12 can be applied as stud bolts to one of the flanges in respective threads (not illustrated) of the receiving holes or can be provided with a head or be simple threaded bars with nuts 13 applied to both opposite ends. This last case is a preferred solution which is used in the exemplary embodiment illustrated.

The nuts 13 are provided with sealing means in order to prevent passages of gas towards the exterior of the flanges 4, 5. In a preferred exemplary embodiment, a first sealing effect is ensured by using blind nuts. A second sealing means is provided by a gasket, for example, of the O-ring 15 type which is received in a circumferential seat 16, for example and preferably, with a trapezoidal cross-section, which is formed in a base 17 of the blind nuts. This base is in abutment against the surface of the corresponding flange 4, 5 when the bolt is clamped on the corresponding screw. It may be observed that the O-ring gasket 15 is such as to be placed circumferentially outside the corresponding hole 11, thereby providing the desired sealing effect.

The auxiliary or safety sealing system 10 according to the invention comprises an annular element 20 to be applied to the flanges 4, 5. The element 20 is closed in the manner of a ring circumferentially on itself and has opposite seats 21, 22 for at least partially receiving the respective flanges 4, 5. The seats 21, 22 are preferably coaxial and are separated by an annular projection 23 which projects radially towards the interior of the element 20 over an axial thickness t1 which is substantially such as to compensate for any gaskets which are interposed between the flanges 4, 5 so as to allow the efficient clamping thereof. The annular projection 23 preferably has such a radial thickness t2 as to be interposed between the flanges 4, 5 with the joint being assembled and clamped.

There is formed in each seat 21, 22 a circumferential recess 25, for example and preferably, with a trapezoidal cross-section, which is intended to receive a gasket 26, for example, an O-ring gasket, which is located in a compressed state at the circumferential edge 27 of the portion of flange 4, 5 which is received in the respective seat when the joint is assembled. Reference will be made in the following text to this seat and the corresponding flange 4, 5 portion as overlapping portion between the seat and the corresponding flange 4, 5. It results in a partial overlap if the flange 4, 5 is received only partially in the corresponding seat (that is to say, it projects axially therefrom) or total overlap if the flange is completely received in the corresponding seat. In the exemplary embodiment illustrated, this overlap is partial.

The annular element 20 preferably has one or more holes 30, which are preferably through-holes and are preferably directed radially towards the interior of the element 20 itself. These holes are preferably provided with a connection 28 which is threaded or however suitable for the sealing connection of a collector 29 for control equipment of the joint which may comprise an interception and controlled discharge device for any leaks, potential transducers and/or detectors of chemical/physical parameters of the environmental conditions present around the flanged connection in the region of the auxiliary sealing system so as to allow active monitoring of the installation in the region of one or more of the flanged connections which form it. The annular element 20 is put into operation during the assembly of the flanges 4, 5 so that they are received in a sealing manner in the respective seats 21, 22 so as to define between the flanges 4, 5 and the annular element 20 an environment which is circumscribed in a sealed manner.

The sealing is brought about by circumferential interference of the flanges with the respective gaskets 26 in the seats 21, 22. Therefore, the clamping means with screws and nuts 12, 13 are applied in such a manner that the gaskets 15 of the base 17 of the nuts 13 are compressed against the facing surfaces of the respective flanges 4, 5.

Finally, there are applied in the threaded connections 28 of the holes 30 the potential transducers and/or collectors or desired monitoring instruments. Where appropriate, the holes 30 will be closed by caps (not illustrated) which are preferably removable, for example, threaded caps, so that by their removal it is possible to gain access to the area surrounding of the flanged connection which is circumscribed by the auxiliary sealing system for any operations, including drainage of any losses, for example, resulting from the failure of the sealing gaskets of the flanged connection.

The invention thereby solves the problem set out while achieving a number of advantages, among which the following ones are set out:
drastically reducing the risk of loss of substances which are hazardous for the environment and for the persons who are working in the installation;
intercepting losses in the flanged joints of the process pipelines and being able to monitor them safely by maintaining the process operating so as to schedule the maintenance thereof, avoiding emergency operating interruptions which cause great damage and costs to the manager of the installation;
reducing the insurance policies of the process installations for hazardous substances because the safety level thereof is increased with a consequent reduction in the risk and containment of the costs resulting from operational incidents;
increasing the protection for the safe working surroundings in the installations which deal with hazardous substances, with a resultant compliance with the laws relating to protecting workers;
increasing the protection for the environment of the territory where the installations which deal with hazardous substances are based, with a resultant compliance with the laws relating to protection of the natural environment and resultant greater guarantee for reducing environmental pollution;
in view of a future focused on recycling and using hydrogen as a completely renewable energy resource, but being extremely flammable, this device becomes a partner in designing the installation by increasing levels of safety of the flanged joints of pipelines, or components such as valves, pumps, instruments and other devices which are assembled with flanges in the installation, allowing the monitoring thereof with remote systems or local instruments.

The device of this invention can then be configured with different gasket seats or additional types and numbers of gaskets, additional accessories, such as securing members, safety seals or other anti-tamper devices in order to be able to more extensively comply with the specific requirements of the process installations defined in the technical specifications of the engineering company which designed the installation and the applicable standards for the type of installation.
The auxiliary sealing system may also be provided with special surface treatments or coverings of various types in order to confer different properties of resistance to corrosion or to make it anti-static and with special additional components it can be made electrically non-conductive from flange to flange, on which it is installed.
The auxiliary sealing system can be constructed with the same materials which constitute the flanges, on which it will be installed, or constructed with different materials. In particular, it may be constructed with durable and recyclable materials, including all steels, ferrous metals and non-ferrous metals, and gaskets of any composite and any polymer or admixture of polymers.

1. An auxiliary sealing system (10) for flanged connections comprising an annular element (20) to be applied to the flanges (4, 5) of said connection and characterized in that said annular element (20) is in the form of a one-piece element which is circumferentially closed on itself and has opposing seats (21, 22) for at least partially receiving said flanges (4, 5) so as to circumferentially circumscribe the corresponding flange (4, 5) when it is received in the corresponding seat (21, 22), each seat (21, 22) being provided with sealing connection means (26) with the corresponding flange (4, 5) so as to define between said flanges (4, 5) and said annular element (20) a circumscribed sealed environment.

2. A sealing system (1) according to claim 1, wherein said seats (21, 22) are coaxial and extend axially in the annular element (20).

3. A sealing system (1) according to claim 1, wherein the sealing (26) between each seat (21, 22) and the corresponding flange (4, 5) is circumferential and is applied between the mutually overlapping portions between seats (21, 22) and flanges (4, 5).

4. A sealing system (1) according to claim 1, wherein said annular element (20) has, in a position between the seats (21, 22) of the flanges (4, 5), an annular projection (23) which projects radially towards the interior of the annular element (20).

5. A sealing system (1) according to claim 4, wherein said annular projection (23) has such an axial thickness (t1) substantially as to compensate for any gaskets interposed between the flanges (4, 5).

6. A sealing system (1) according to claim 4, wherein said annular projection (23) has such a radial thickness (t2) as to be interposed between the flanges (4, 5) when the joint is assembled and clamped.

7. A sealing system (1) according to claim 1, wherein in said annular element (20) there is formed at least one intercommunication passage (30) between said sealed circumscribed environment and the external environment.

8. A sealing system (1) according to claim 7, wherein said passage (30) can be intercepted.

9. A sealing system (1) according to claim 7, wherein said passage (30) constitutes a housing for transducers.

10. A sealing system (1) according to claim 1, comprising clamping screws (12) and nuts (13) of the flanges provided with sealing connection means between the screws (12) and the nuts (13) and between the nuts (13) and the flanges (4, 5).

11. A sealing system (1) according to claim 10, wherein the sealing means between the screws (12) and the nuts (13) are formed by blind nuts.

12. A sealing system (1) according to claim 10, wherein the sealing means between the nuts (13) and the flanges comprise gaskets (15) interposed between a base (17) of each nut (13) and the respective flange (4, 5).
